(19) United States
(12) Patent Application Publication
(10) Pub. No.: US 2016/0163090 A1
(43) Pub. Date: Jun. 9, 2016

(54) COMPUTING DEVICE AND METHOD FOR SIMULATING PROCESS OF SCANNING DRAWING OF OBJECT

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); JING-JIE SHEN, Shenzhen (CN)

(21) Appl. No.: 14/753,708

(22) Filed: Jun. 29, 2015

(30) Foreign Application Priority Data
Dec. 5, 2014 (CN) 201410737415.7

(51) Int. Cl. G06T 15/10; G06T 11/20

(52) U.S. Cl. CPC G06T 15/10; G06T 11/20

(57) ABSTRACT

A computing device and a method simulate a process of scanning a drawing of a three-dimensional (3D) object. The computing device triangulates a three-dimensional (3D) object using a plurality of 3D triangles. The computing device obtains converts the drawing of the 3D object into a drawing of a two-dimensional (2D) object. The computing device obtains 2D triangles from the drawing of the 2D object and displays the 2D triangles onto the drawing of the 3D object.

### CROSS-REFERENCE TO RELATED APPLICATIONS

This application claims priority to Chinese Patent Application No. 201410737415.7 filed on Dec. 5, 2014, the contents of which are incorporated by reference herein.

### FIELD

The subject matter herein generally relates to simulation technology, and particularly to a computing device and a method for simulating a process of scanning an object.

### BACKGROUND

A scanner (for example, a laser scanner) is commonly used to scan a surface of various objects (for example, a shell of a mobile phone). However, the scanner may fail after a large number of uses. For example, a lens of the scanner may need to be periodically changed.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a computing device.

FIG. 2 is a block diagram of an example embodiment of a simulation system included in the computing device.

FIG. 3 shows an isometric view of an example of a drawing of a 3D object.

FIG. 4 shows an isometric view of an example of a simulated scanner.

FIG. 5 is a flowchart of an example embodiment of a method for simulating a process of scanning the drawing of the 3D object.

FIG. 6 is a flow chart of a detailed description of block 301 in FIG. 5.

FIG. 7 shows a diagrammatic view of an example of a 2D image of light.

FIG. 8 shows a diagrammatic view of an example of an enlarged 2D image of light.

FIG. 9 shows an isometric view of an example of a scanning area of the simulated scanner.

FIG. 10 shows an isometric view of an example of scanning the drawing of the 3D object using the simulated scanner.

FIG. 11 shows a diagrammatic view of an example of a 2D object.

FIG. 12 shows a diagrammatic view of an example of a partial drawing of the 3D object after the drawing of the 3D object being scanned by the simulated scanner.

FIG. 13 shows a diagrammatic view of a triangle on the 2D image of the light.

FIG. 14 shows a diagrammatic view of an example of triangulating the drawing of the 3D object.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

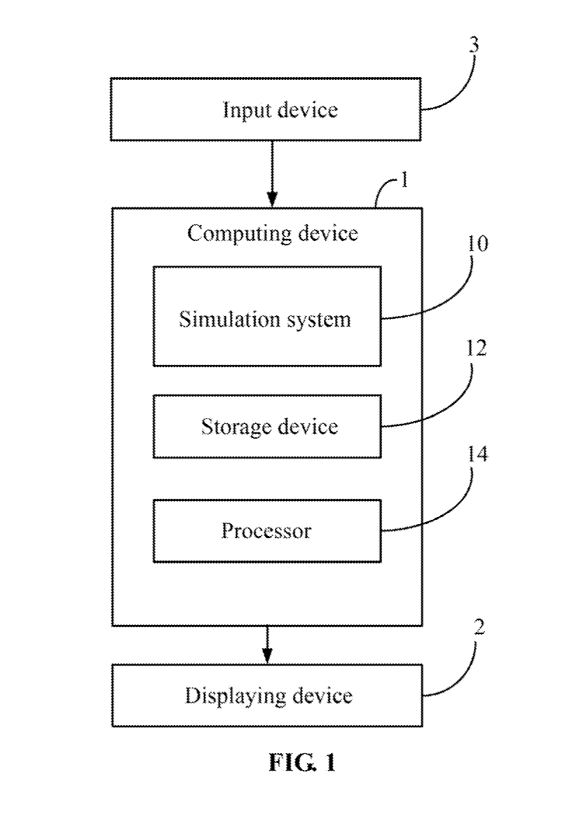

FIG. 1 illustrates a block diagram of an example embodiment of a computing device 1. In the embodiment, the computing device 1 provides various functional connections to connect with a displaying device 2, and an input device 3. The computing device 1 provides a user interface, which is displayed on the displaying device 2. One or more operations of the computing device 1 can be controlled by a user through the user interface. For example, the user may input an ID and a password using an input device 3 (e.g., a keyboard and a mouse) into the user interface to access the computing device 1. The computing device 1 can be, but is not limited to, a tablet computer, a server, a personal computer or any other computing device. In the example embodiment, the computing device 1 includes, but is not limited to, a simulation system 10, a storage device 12, and at least one processor 14. FIG. 1 illustrates only one example of the computing device 1, and other examples can comprise more or fewer components than those shown in the embodiment, or have a different configuration of the various components.

In at least one embodiment, the storage device 12 can be an internal storage device, such as a flash memory, a random access memory (RAM) for temporary storage of information, and/or a read-only memory (ROM) for permanent storage of information. The storage device 12 can also be an external storage device, such as an external hard disk, a storage card, or a data storage medium. The at least one processor 14 can be a central processing unit (CPU), a microprocessor, or other data processor chip that performs functions of the computing device 1.

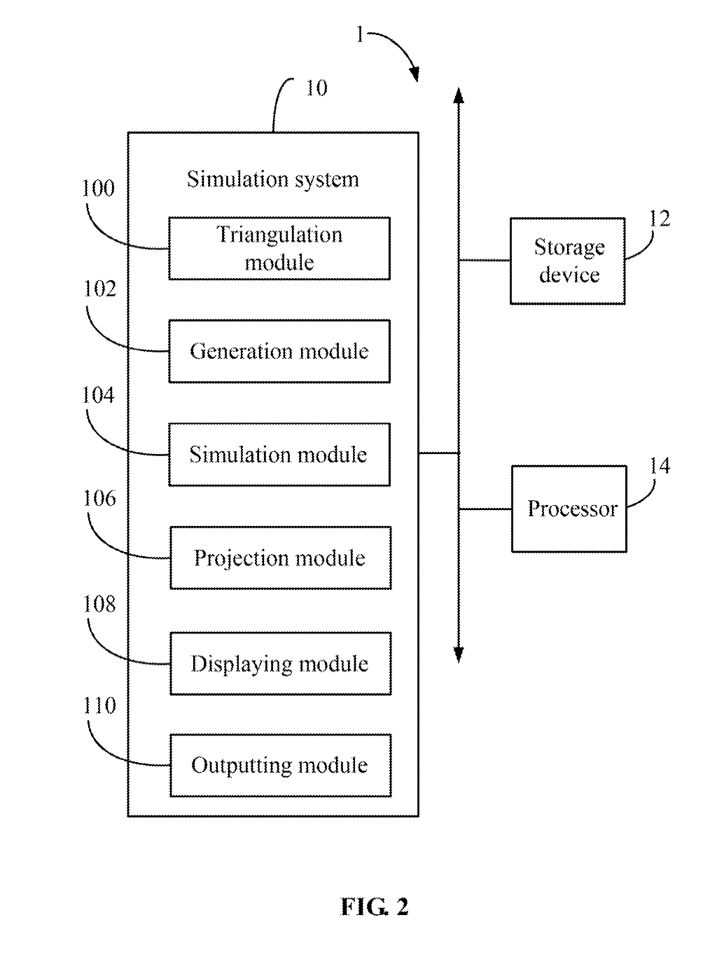

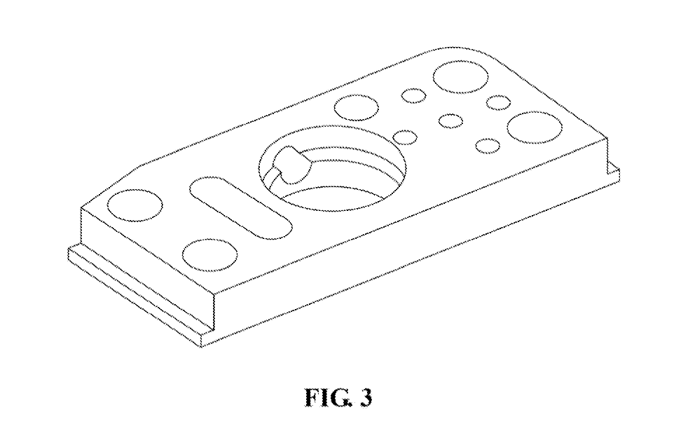

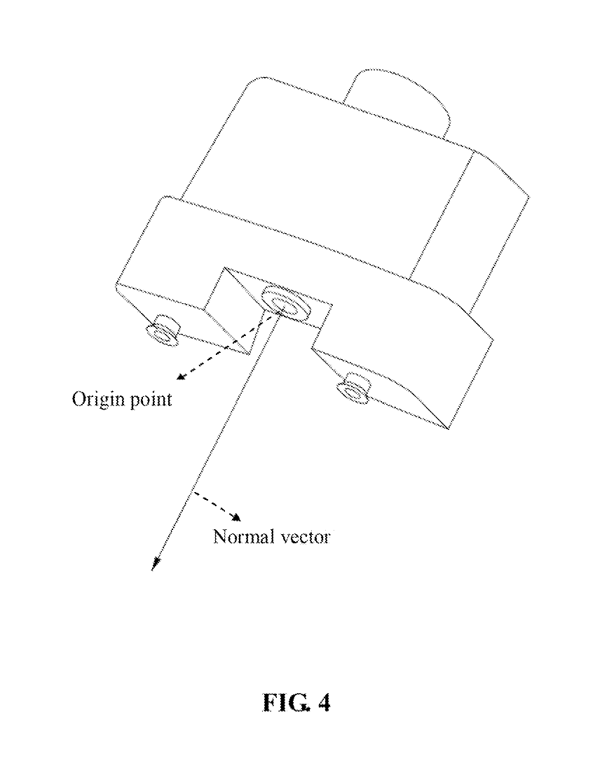

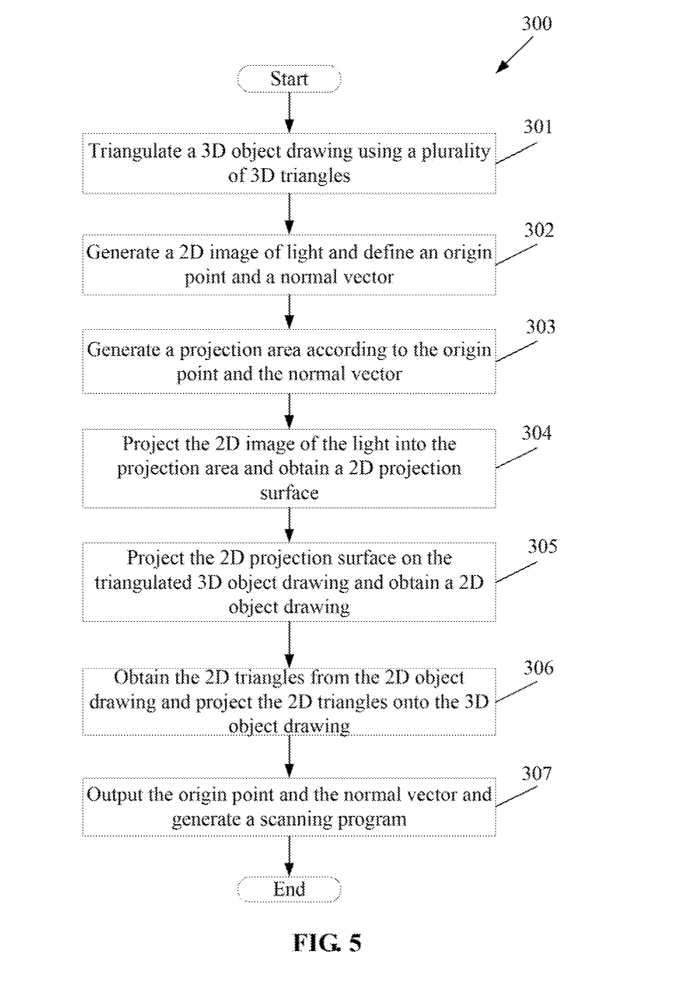

FIG. 2 illustrates a block diagram of an example embodiment of the simulation system 10 included in the computing device 1. In at least one embodiment, the simulation system 10 can include, but is not limited to, a triangulation module 100, a generation module 102, a simulation module 104, a projection module 106, a displaying module 108, and an outputting module 110. The modules 100-110 can comprise computerized instructions in the form of one or more computer-readable programs that can be stored in a non-transitory computer-readable medium, such as the storage device 12, and be executed by the at least one processor 14 of the computing device 1. The storage device 12 includes a drawing of a three-dimensional (3D) object, such as shown in FIG. 3. For example, the drawing of the 3D object can be, but is not limited to, a 3D computer aided design (CAD) drawing. Furthermore, the storage device 12 includes a simulated scanner, as shown in FIG. 4. The simulated scanner is an application which runs in the computing device 1. The simulated scanner is capable of emitting light which is projected onto the drawing of the 3D object. Detailed descriptions of functions of the modules are given below in reference to FIG. 5.

FIG. 5 illustrates a flowchart of an example embodiment of a method for simulating a process of scanning a drawing of a 3D object. In an example embodiment, the method is performed by execution of computer-readable software program codes or instructions by at least one processor of a computing device.

Referring to FIG. 5, a flowchart is presented in accordance with an example embodiment. The method 300 is provided by way of example, as there are a variety of ways to carry out the method. The method 300 described below can be carried out using the configurations illustrated in FIGS. 1 and 5, for example, and various elements of these figures are referenced in explaining example method 300. Each block shown in FIG. 5 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The example method 300 can begin at block 301.

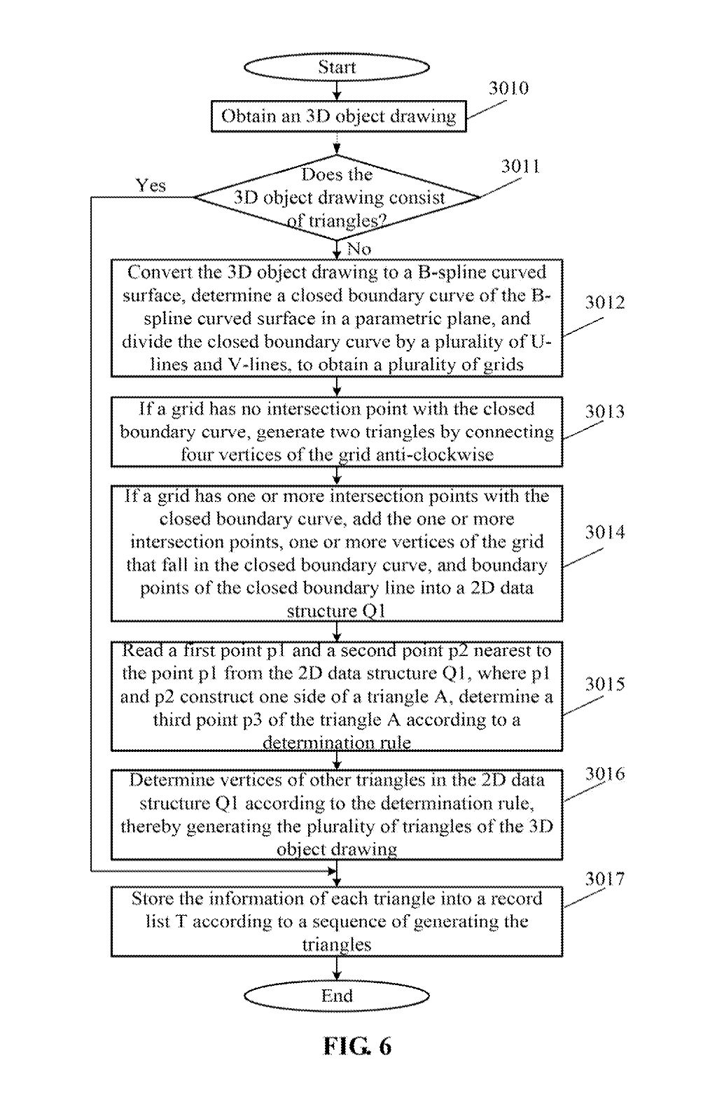

At block 301, the triangulation module triangulates the drawing of the 3D object using a plurality of 3D triangles. In at least one embodiment, the drawing of the 3D object can be represented by the plurality of the 3D triangles after triangulation. Each of the 3D triangles is assigned to a serial number after the drawing of the 3D object has been triangulated. The detail description of triangulating the drawing of the 3D object using a plurality of 3D triangles is described in FIG. 6.

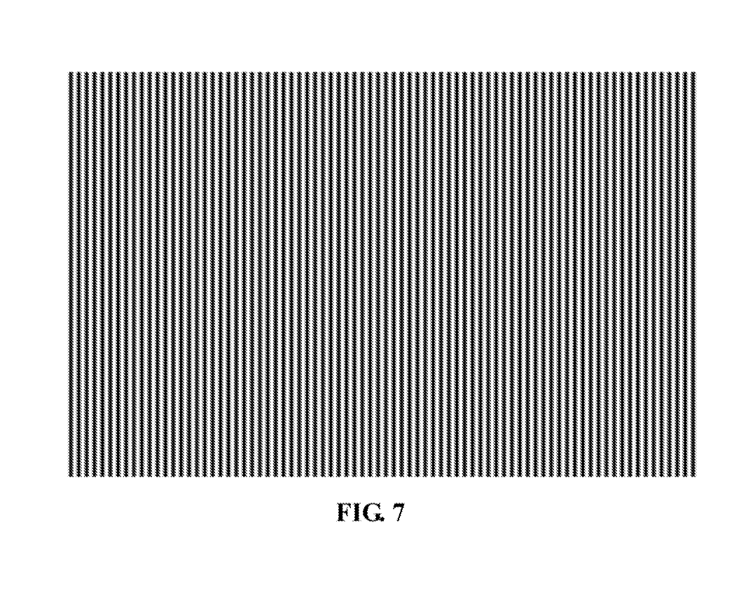

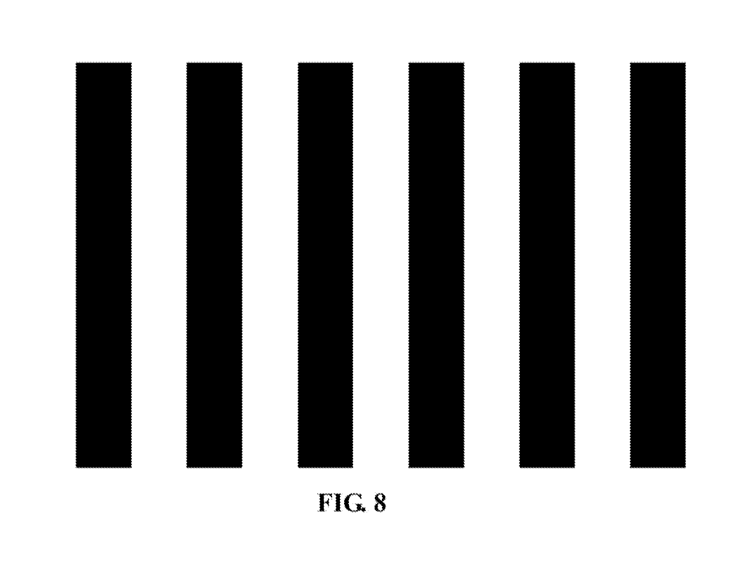

At block 302, the simulation module generates a two-dimensional (2D) image of light and defines an origin point and a normal vector. In at least one embodiment, the 2D image of light can be, but is not limited to, be formed by specified patterns or images, such as, black stripes and white stripes as shown in FIGS. 7-8. The 2D image of light is generated when the light passes through a pattern (for example, black stripes and white stripes as shown in FIGS. 7-8) and projects the patterns on a surface (for example, a wall or a projection screen). The origin point is defined as a position where the light emits from a lens of the simulated scanner as shown in FIG. 4. The normal vector is a direction of the lens of the simulated scanner as shown in FIG. 4. The origin point and the normal vector are used for locating the simulated scanner.

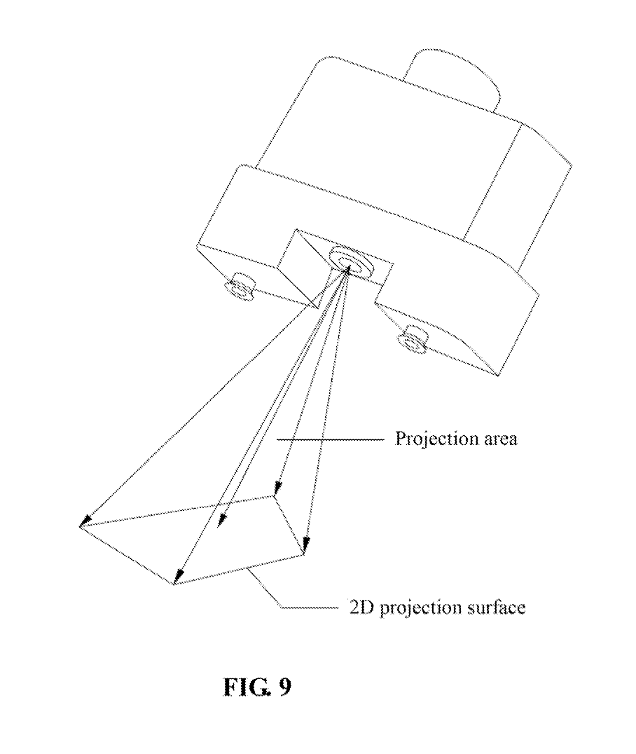

At block 303, the simulation module generates a projection area according to the origin point and the normal vector. The projection area encloses a cubic area as shown in FIG. 9.

At block 304, the projection module projects the 2D image of the light into the projection area and obtains a 2D projection surface. The 2D projection surface may be, but is not limited to, a quadrilateral plane as shown in FIG. 9. The 2D projection surface may, however, be a circular plane, an oval plane or other plane shape known in the art. A range of the 2D projection surface can be determined by a distance of the normal vector.

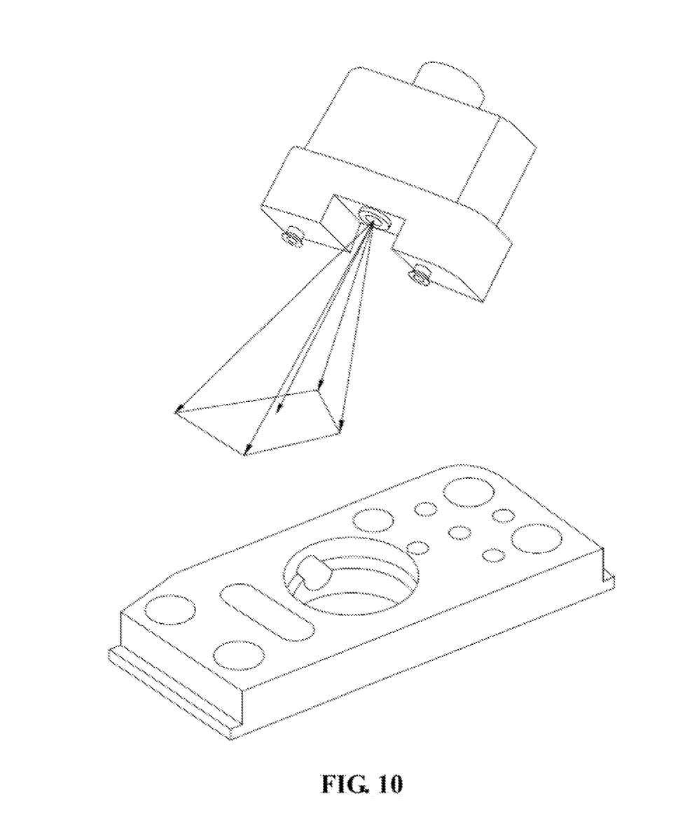

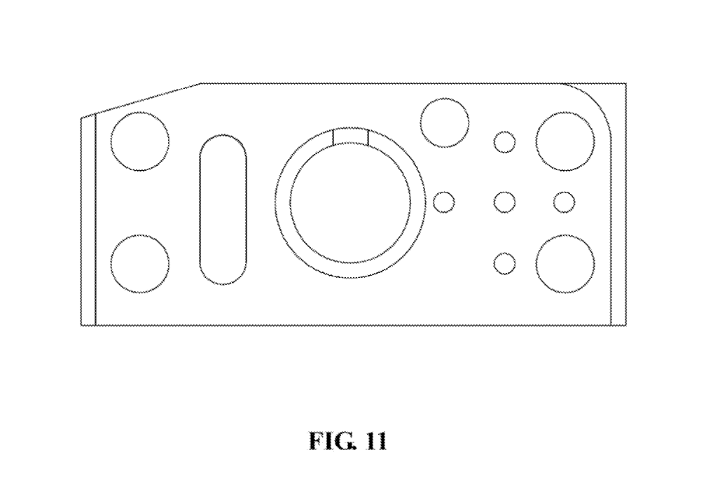

At block 305, the projection module projects the 2D projection surface onto the drawing of the triangulated 3D object and obtain a drawing of a 2D object. As shown in FIG. 10, the 2D projection surface is projected onto the drawing of the triangulated 3D object, and as shown in FIG. 11, the drawing of the 2D object is obtained.

At block 306, the displaying module obtains the 2D triangles from the drawing of the 2D object and displays the 2D triangles onto the drawing of the 3D object.

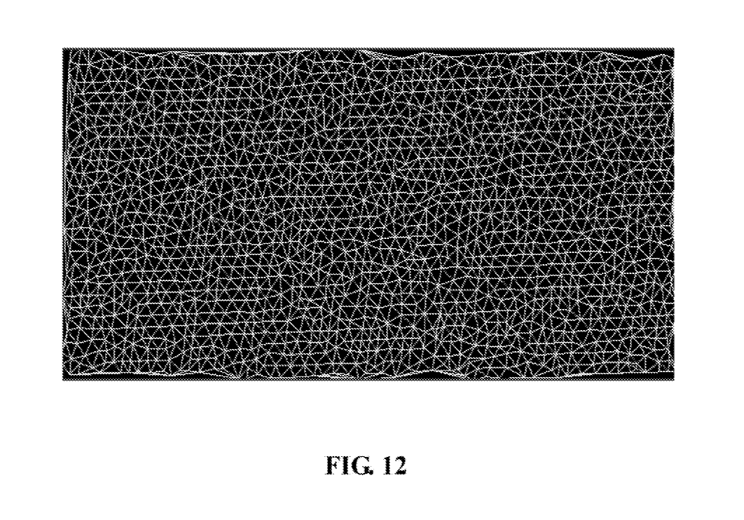

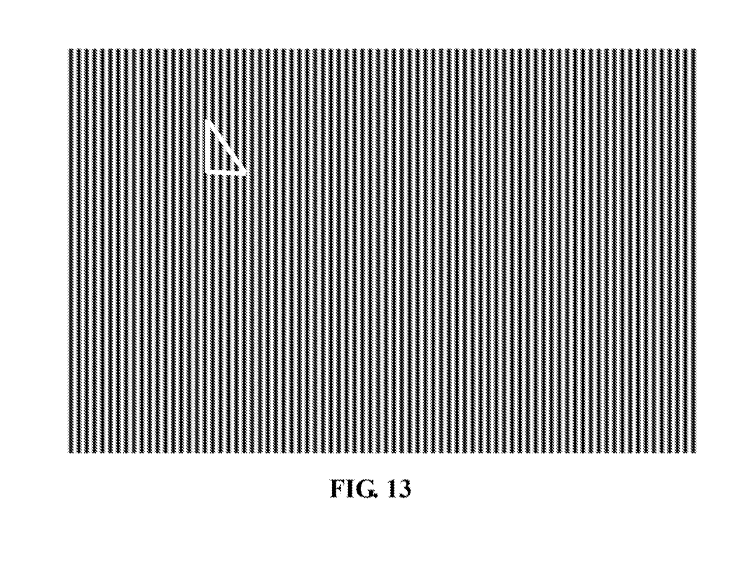

In at least one embodiment, the 2D triangles of the drawing of the 2D object is shown in FIG. 12, and each of the 2D triangles of the drawing of the 2D object is displayed onto the drawing of the 3D object as shown in FIG. 13. In detail, each of the 3D triangles of the drawing of the 3D object includes a serial number which is shared by a 2D triangle of the drawing of the 2D object after the 3D triangle is converted into the 2D triangle. For example, if the serial number of the 3D triangle is “0000001”, after the 3D triangle is converted into a 2D triangle, the serial number of the 2D triangle is also “0000001.” Thus, the displaying module displays the 2D triangles onto the drawing of the 3D object according to the serial numbers of the drawing of the 2D object.

At block 307, the outputting module generates a scanning program which includes programmed computerized code of the modules 100-108. The scanning program repeatedly executes from the module 100 to the module 108 in order when a user starts the scanning program. The scanning program includes functions of the modules 100-108. The outputting module outputs the origin point and the normal vector when the scanning program is generated. Furthermore, the scanning program also includes the origin point and the normal vector, and the user does not need to define the origin point and the normal vector when starting the scanning program. That is, the simulated scanner moves to the position which is determined by the origin point and the normal vector when the scanning program is started. Additionally, the outputting module displays the scanning program on the display device, and stores the scanning program into the storage system.

FIG. 6 is a detailed description of block 301 in FIG. 5. Depending on the embodiment, additional blocks may be added, others removed, and the ordering of the blocks may be changed.

At block 3010, the triangulation module reads the drawing of the 3D object from the storage device.

At block 3011, the triangulation module determines that if the drawing of the 3D object consists of 3D triangles. If the drawing of the 3D object consists of 3D triangles, the procedure directly goes to 3017. Otherwise, if the drawing of the 3D object does not consist of 3D triangles, the procedure goes to block 3012.

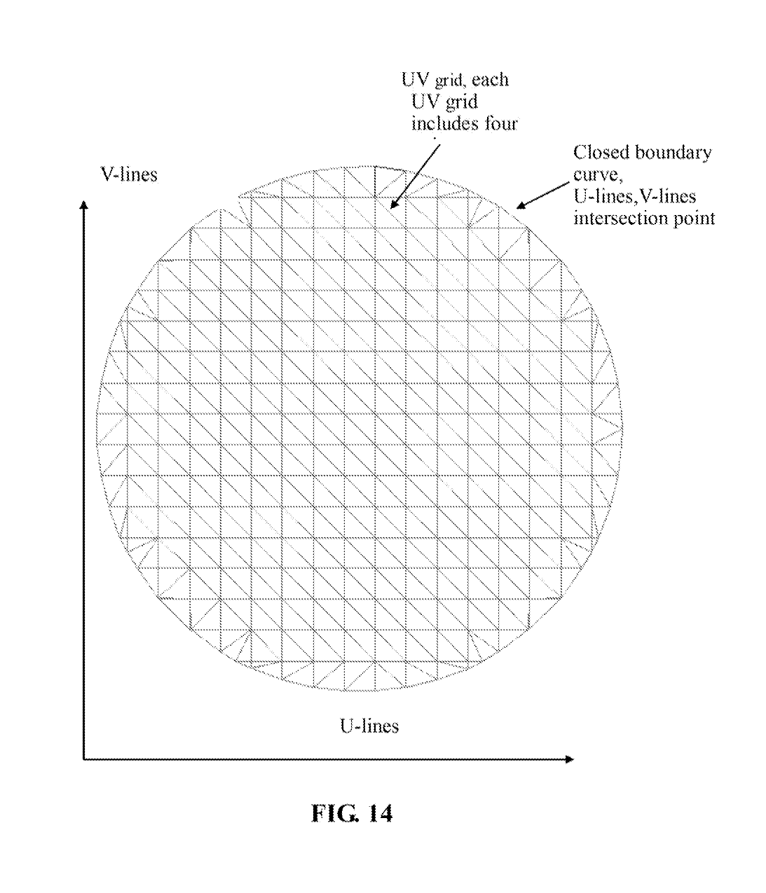

At block 3012, the triangulation module converts the drawing of the 3D object to a B-spline curved surface, determines a closed boundary curve of the B-spline curved surface in a parametric plane, and divides the closed boundary curve by a plurality of horizontal lines (hereinafter referred to “U-lines”) and vertical lines (hereinafter referred to “V-lines”), to obtain a plurality of grids (as shown in FIG. 14).

At block 3013, if a grid has no intersection point with the closed boundary curve, the triangulation module generates two triangles by connecting four vertices of the grid anti-clockwise.

At block 3014, if a grid has one or more intersection points with the closed boundary curve, the triangulation module adds the one or more intersection points, one or more vertices of the grid which fall in the closed boundary curve, and boundary points of the closed boundary line into a 2D data structure Q1.

At block 3015, the triangulation module reads a first point p1 and a second point p2 nearest to the point p1 from the 2D data structure Q1, where p1 and p2 construct one side of a triangle A. The triangulation module further determines a third point p3 of the triangle A according to a determination rule that there is no 2D point of the 2D data structure Q1 in a circumcircle of the triangle A consisted by the points p1, p2, and p3.

At block 3016, the triangulation module determines vertices of other triangles in the 2D data structure Q1 according to the determination rule, to generate the plurality of triangles of the drawing of the 3D object.

At block 3017, the triangulation module stores the information of each triangle into a record list T according to a sequence of generating the triangles.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A computing device comprising:
at least one processor; and
a storage device coupled to the at least one processor and configured to store one or more programs, which when executed by the at least one processor, cause the at least one processor to:
triangulate a drawing of a three-dimensional (3D) object using a plurality of 3D triangles;
generate a two-dimensional (2D) image of light and define an origin point and a normal vector;
generate a projection area according to the origin point and the normal vector;
project the 2D image of the light into the projection area;
obtain a 2D projection surface;
project the 2D projection surface onto the drawing of the triangulated 3D object;
obtain a drawing of a 2D object from the projection of the 2D projection surface onto the drawing of the triangulated 3D object;
obtain the 2D triangles from the drawing of the 2D object; and
display the 2D triangles onto the drawing of the 3D object.

2. The computing device of claim 1, wherein the at least one processor further generates a scanning program.

3. The computing device of claim 1, wherein the 2D image of light is generated when the light passes through a pattern and projects the patterns on a surface.

4. The computing device of claim 1, wherein the origin point is defined as a position where the light emits from a lens of a simulated scanner, and the normal vector is a direction of the lens of the simulated scanner.

5. The computing device of claim 1, wherein the 2D triangles are displayed onto the drawing of the 3D object according to serial numbers of the drawing of the 2D object.

6. The computing device of claim 1, wherein the drawing of the 3D object is triangulated using a plurality of 3D triangles by performing steps of:
reading the drawing of the 3D object from the storage device;
converting the drawing of the 3D object to a B-spline curved surface when the drawing of the 3D object does not consist of 3D triangles;
determining a closed boundary curve of the B-spline curved surface in a parametric plane, and dividing the closed boundary curve by a plurality of horizontal lines and vertical lines, to obtain a plurality of grids;
generating two triangles by connecting four vertices of the grid anti-clockwise when a grid has no intersection point with the closed boundary curve;
adding the one or more intersection points, one or more vertices of the grid which fall in the closed boundary curve, and boundary points of the closed boundary line into a 2D data structure Q1 a grid has one or more intersection points with the closed boundary curve;
reading a first point pl and a second point p2 nearest to the point p1 from the 2D data structure Q1, where p1 and p2 construct one side of a triangle A;
determining vertices of other triangles in the 2D data structure Q1 according to the determination rule;
generating the plurality of triangles of the drawing of the 3D object; and
storing the information of each triangle into a record list T according to a sequence of generating the triangles.

7. A computer-based method for a process of scanning a drawing of a three-dimensional (3D) object using a computing device, the simulation method comprising:
triangulating the drawing of the 3D object using a plurality of 3D triangles;
generating a two-dimensional (2D) image of light and defining an origin point and a normal vector;
generating a projection area according to the origin point and the normal vector;
projecting the 2D image of the light into the projection area;
obtaining a 2D projection surface;
projecting the 2D projection surface onto the drawing of the triangulated 3D object;
obtaining a drawing of a 2D object from the projection of the 2D projection surface onto the drawing of the triangulated 3D object;
obtaining the 2D triangles from the drawing of the 2D object; and
displaying the 2D triangles onto the drawing of the 3D object.

8. The method of claim 7, further comprising:
generating a scanning program.

9. The method of claim 7, wherein the 2D image of light is generated when the light passes through a pattern and projects the patterns on a surface.

10. The method of claim 7, wherein the origin point is defined as a position where the light emits from a lens of a simulated scanner, and the normal vector is a direction of the lens of the simulated scanner.

11. The method of claim 7, wherein the 2D triangles are displayed onto the drawing of the 3D object according to serial numbers of the drawing of the 2D object.

12. The method of claim 7, wherein the drawing of the 3D object is triangulated using a plurality of 3D triangles by performing steps of:
reading the drawing of the 3D object from the storage device;
converting the drawing of the 3D object to a B-spline curved surface when the drawing of the 3D object does not consist of 3D triangles;
determining a closed boundary curve of the B-spline curved surface in a parametric plane, and dividing the closed boundary curve by a plurality of horizontal lines and vertical lines, to obtain a plurality of grids;
generating two triangles by connecting four vertices of the grid anti-clockwise when a grid has no intersection point with the closed boundary curve;
adding the one or more intersection points, one or more vertices of the grid which fall in the closed boundary curve, and boundary points of the closed boundary line into a 2D data structure Q1 a grid has one or more intersection points with the closed boundary curve;
reading a first point p1 and a second point p2 nearest to the point p1 from the 2D data structure Q1, where pl and p2 construct one side of a triangle A;
determining vertices of other triangles in the 2D data structure Q1 according to the determination rule;
generating the plurality of triangles of the drawing of the 3D object; and
storing the information of each triangle into a record list T according to a sequence of generating the triangles.

13. A non-transitory computer-readable medium having stored thereon instructions that, when executed by at least one processor of a computing device, causing the computing device to perform a method for simulating a process of scanning a drawing of a three-dimensional (3D) object, the method comprising:
triangulating the drawing of the 3D object using a plurality of 3D triangles;
generating a two-dimensional (2D) image of light and defining an origin point and a normal vector;
generating a projection area according to the origin point and the normal vector;
projecting the 2D image of the light into the projection area;
obtaining a 2D projection surface;
projecting the 2D projection surface onto the drawing of the triangulated 3D object;
obtaining a drawing of a 2D object from the projection of the 2D projection surface onto the drawing of the triangulated 3D object;
obtaining the 2D triangles from the drawing of the 2D object; and
displaying the 2D triangles onto the drawing of the 3D object.

14. The non-transitory computer-readable medium of claim 13, wherein the method further comprising:
generating a scanning program.

15. The non-transitory computer-readable medium of claim 13, wherein the 2D image of light is generated when the light passes through a pattern and projects the patterns on a surface.

16. The non-transitory computer-readable medium of claim 13, wherein the origin point is defined as a position where the light emits from a lens of a simulated scanner, and the normal vector is a direction of the lens of the simulated scanner.

17. The non-transitory computer-readable medium of claim 13, wherein the 2D triangles are displayed onto the drawing of the 3D object according to serial numbers of the drawing of the 2D object.

18. The non-transitory computer-readable medium of claim 13, wherein the drawing of the 3D object is triangulated using a plurality of 3D triangles by performing steps of:
reading the drawing of the 3D object from the storage device;
converting the drawing of the 3D object to a B-spline curved surface when the drawing of the 3D object does not consist of 3D triangles;
determining a closed boundary curve of the B-spline curved surface in a parametric plane, and dividing the closed boundary curve by a plurality of horizontal lines and vertical lines, to obtain a plurality of grids;
generating two triangles by connecting four vertices of the grid anti-clockwise when a grid has no intersection point with the closed boundary curve;
adding the one or more intersection points, one or more vertices of the grid which fall in the closed boundary curve, and boundary points of the closed boundary line into a 2D data structure Q1 a grid has one or more intersection points with the closed boundary curve;
reading a first point p1 and a second point p2 nearest to the point p1 from the 2D data structure Q1, where p1 and p2 construct one side of a triangle A;
determining vertices of other triangles in the 2D data structure Q1 according to the determination rule;
generating the plurality of triangles of the drawing of the 3D object; and
storing the information of each triangle into a record list T according to a sequence of generating the triangles.
